(19) United States
(12) Patent Application Publication
(10) Pub. No.: US 2007/0008692 A1
(43) Pub. Date: Jan. 11, 2007

(54) Laptop safety carrier

(76) Inventor: Lawrence A. Staples, Wilmington, DE (US)

Correspondence Address: JAMES RAY & ASSOCIATES, 2640 PITCAIRN ROAD, MONROEVILLE, PA, 15146, US

(21) Appl. No.: 11/483,320

(22) Filed: Jul. 7, 2006

Related U.S. Application Data
(60) Provisional application No. 60/697,243, filed on Jul. 7, 2005.

(51) Int. Cl. G06F 1/16; F21V 21/00

(52) U.S. Cl. 361/683; 248/226.11

(57) ABSTRACT

An apparatus for carrying a laptop computer. The apparatus comprises an elongated strip for wrapping around such laptop computer. Such elongated strip having a predetermined length and a predetermined width and formed of a preselected material. There is a means for securing a first end of such elongated strip to another portion of the elongated strip after the elongated strip has enclosed such laptop computer. A handle member is engageable with the elongated strip for carrying such laptop computer once such laptop computer is enclosed in such elongated strip.

### CROSS REFERENCE TO RELATED APPLICATIONS

This application is closely related to and claims benefit from U.S. Provisional Application Ser. No. 60/697,243 filed Jul. 7, 2005.

### FIELD OF THE INVENTION

The present invention relates, in general, to a lap top computer, and, more particularly, the present invention relates to a safety carrier for such laptop or notebook computer which makes it safe for carrying such computer without the need for the carrying case.

### BACKGROUND OF THE INVENTION

Laptop or notebook computers are becoming increasingly more popular. Keeping a notebook computer in your hands without using the case is easy and convenient for transport but not so convenient for carrying. Unloading or loading your laptop in a storage bin can be costly if such device is dropped, slides around or comes in contact with damaging materials.

It would be advantageous and convenient if there were a means for keeping the laptop computer from slipping out of a person's hands while trying to get it in or out of a storage container and make the laptop easy to handle and safer for carrying.

### SUMMARY OF THE INVENTION

In a first aspect the invention provides for an apparatus for carrying a laptop computer. The apparatus comprises an elongated strip for wrapping around such laptop computer. Such elongated strip having a predetermined length and a predetermined width and formed of a preselected material. There is a means for securing a first end of such elongated strip to another portion of the elongated strip after the elongated strip has enclosed such laptop computer. A handle member is engageable with the elongated strip for carrying such laptop computer once such laptop computer is enclosed in such elongated strip.

### OBJECTS OF THE INVENTION

It is, therefore, one of the primary objects of the present invention to provide a safety carrier that can be used to carry a laptop or notebook computer safely and securely.

Another object of the present invention is to provide a safety carrier that can be used to carry a laptop or notebook computer that is easy to use.

Still another object of the present invention is to provide a safety carrier that can be used to carry a laptop or notebook computer that has a convenient carrying handle.

Yet another object of the present invention is to provide a safety carrier that can be used to carry a laptop or notebook computer that does not require the use of the case.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus according to an embodiment of the invention showing a laptop computer with the apparatus attached.

FIG. 2 is a perspective view of the top side of the apparatus.

FIG. 3 is a perspective view of the underside of the apparatus.

FIG. 4 is a perspective view of the apparatus with the elongated strip folded over showing the means for securing.

FIG. 5 is a perspective view of the apparatus according to an alternate embodiment of the invention.

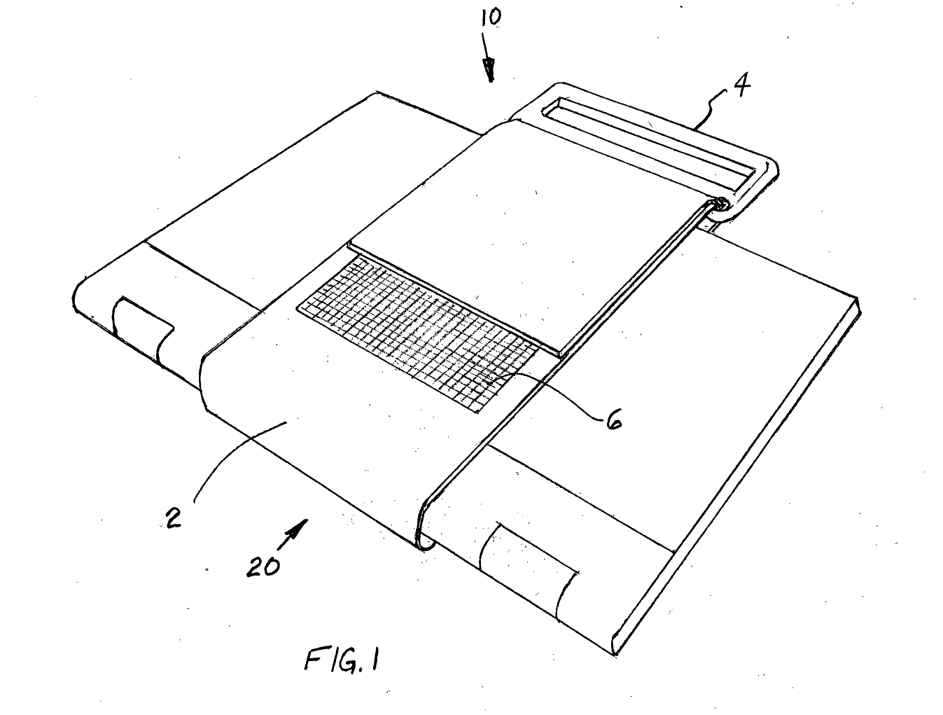

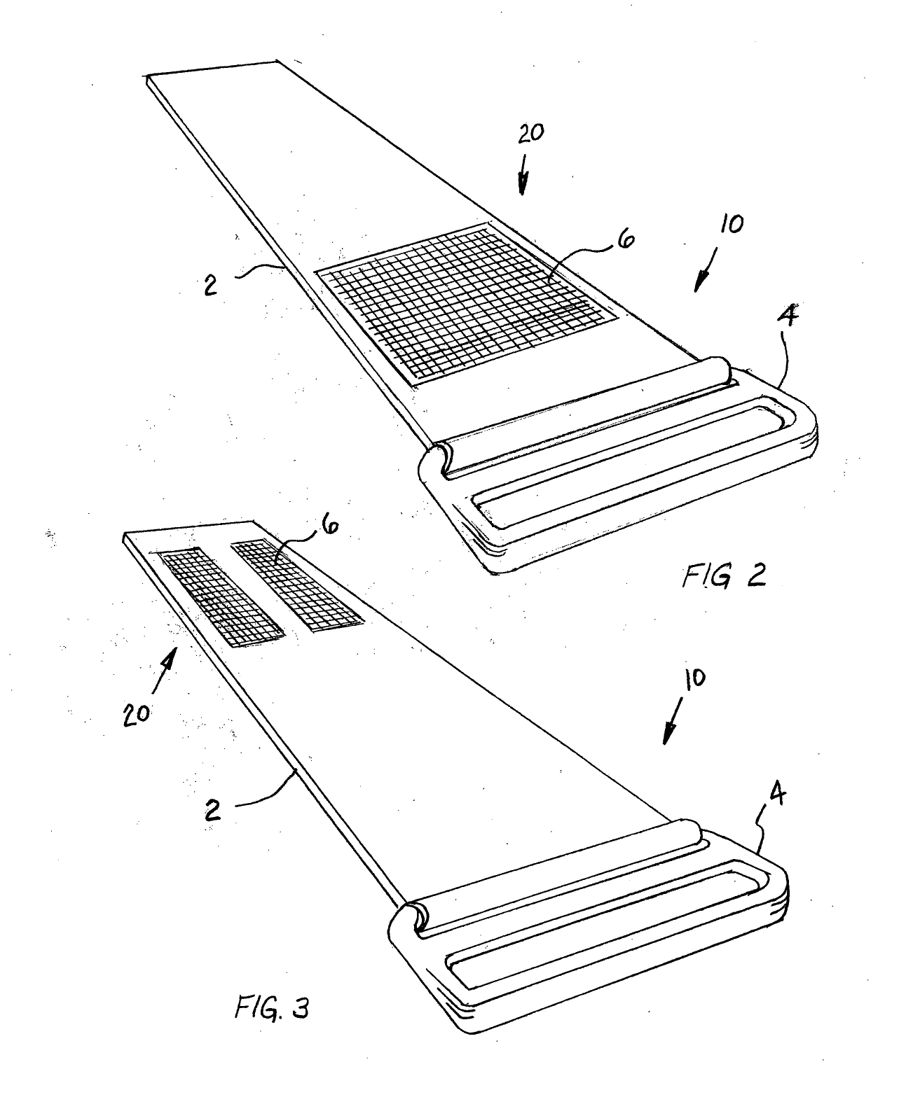

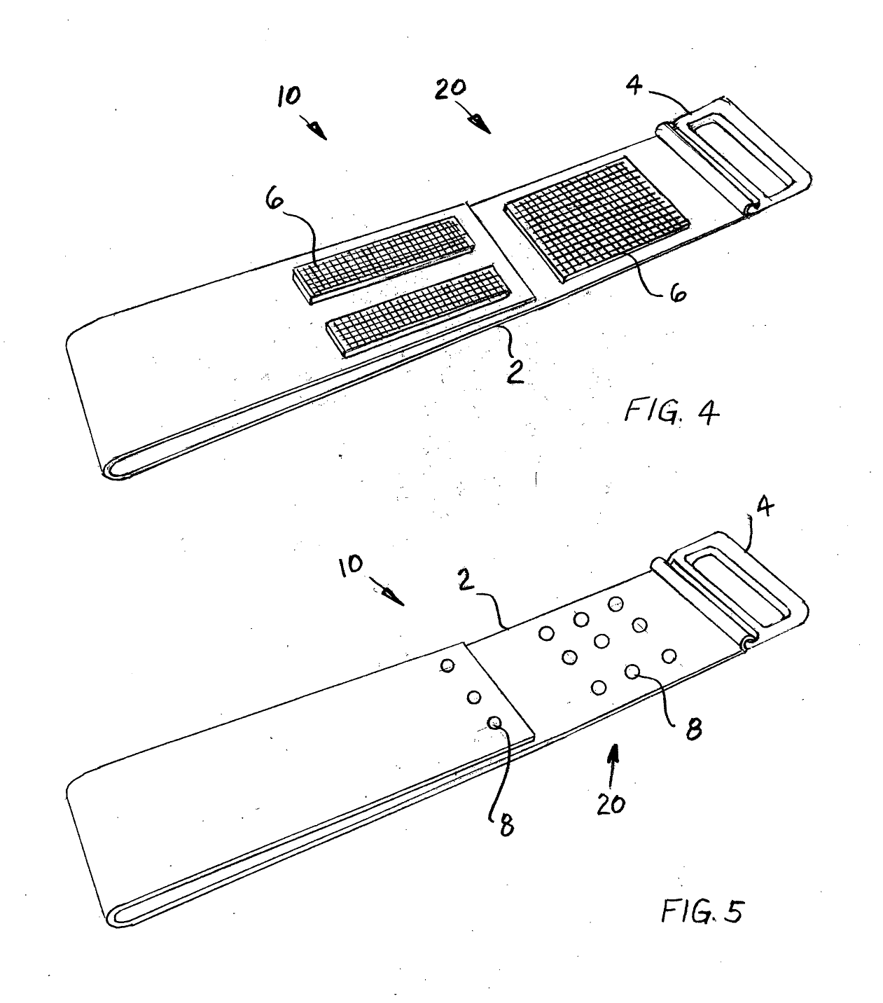

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the invention provides for an apparatus, generally designated 10, for carrying a laptop computer. The apparatus 10 comprises an elongated strip 2 for wrapping around such laptop computer. Such elongated strip 2 having a predetermined length and a predetermined width and formed of a preselected material. There is a means, generally designated 20, for securing a first end of such elongated strip 2 to another portion of the elongated strip 2 after the elongated strip 2 has encircled at least a portion of such laptop computer. A handle member 4 is engageable with the elongated strip 2 for carrying such laptop computer once such elongated strip 2 is encircled around and secured to such laptop computer.

Such first end of the elongated strip 2 is secured to another portion of such elongated strip 2 by means of one of hook and loop attachments 6, snaps 8, hooks and buckles. It is presently preferred that such means for securing 20 is a hook and loop attachment 6 (Velcro). Velcro is a registered trademark of Velcro Industries B.V.

As is seen in the drawing Figures such handle member 4 is engageable with the second end of such elongated strip 2. It is presently preferred that such handle member 4 is securely attached to such second end of the elongated strip 2. It is also preferred that such elongated strip 2 pass through the handle member 4 as it encircles such laptop computer. Such handle member has a slot disposed therein closely adjacent to where such handle member is attached to such second end of the elongated strip 2 where such elongated strip 2 can pass through the handle as it encircles the laptop.

Such predetermined width of the elongated strip 2 is between about 3.75 inches and about 5.25 inches. If is further preferred that such predetermined width of the elongated strip 2 is between about 4.25 inches and about 5 inches.

The preselected material for such elongated strip 2 is selected from one of plastic, rubber, nylon, and synthetic leather. It is presently preferred that such preselected material is rubber and even more preferred that rubber is a synthetic rubber and that such synthetic rubber is a thermoplastic elastomer. One such thermoplastic elastomer is Sanoprene. Sanoprene is a trade mark of Reed Rubber and Foam Products. It is also an embodiment of the invention that such handle member also be made of a preselected material. Such preselected material is selected from one of plastic, rubber, nylon, and synthetic leather. It is preferred that such handle member also be made of a thermoplastic elastomer.

Another embodiment of the invention as seen in FIG. 5 provides that snaps 8, hooks or buckles may be used to secure the first end of elongated strip 2 to another portion of the elongated strip 2.

Yet, another embodiment of the invention provides a weather proof cover which fits over such laptop computer with the apparatus 10 that is attached to such laptop computer leaving the handle member 4 free so as to protect such computer from rain and other weather elements.

It is within the scope of the invention that such apparatus 10 can be provided in a variety of colors, styles and designs to meet everyone's tastes. Further, it is possible to attach a pouch to the apparatus 10 for additional storage, if desired. Also, as stated previously, there is an all weather cover, made of soft durable material, that can fit over the apparatus with the laptop secured therein which can protect the laptop against a variety of weather elements.

Thus, the present invention provides a laptop carrier member with a handle which will keep the laptop from slipping out of the user's hands and makes the laptop easy to handle and safer for carrying without the need of the case for the laptop computer.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An apparatus for carrying a laptop computer, said apparatus comprising:
(a) an elongated strip for wrapping around such laptop computer, said elongated strip having a predetermined length and a predetermined width and formed of a preselected material;
(b) a means for securing a first end of such elongated strip to another portion of said elongated strip after said elongated strip has encircled at least a portion of such laptop computer; and
(c) a handle member engageable with said elongated strip for carrying such laptop computer once said elongated strip is encircled around and secured to such.

2. The apparatus, according to claim 1, wherein said means for securing said first end of said elongated strip to said another portion of said elongated strip after said elongated strip has encircled at least a portion of such laptop computer includes hook and loop attachments.

3. The apparatus, according to claim 1, wherein said handle member is engageable with a second end of said elongated strip.

4. The apparatus, according to claim 3, wherein said handle means is securely attached to said second end of said elongated strip.

5. The apparatus, according to claim 1, wherein said handle member is made of a preselected material.

6. The apparatus, according to claim 5, wherein said preselected material is selected from one of plastic, rubber, nylon, and synthetic leather.

7. The apparatus, according to claim 6, wherein said preselected material is a thermoplastic elastomer.

8. The apparatus, according to claim 1, wherein said predetermined width of said elongated strip is between about 3.75 inches and about 5.25 inches.

9. The apparatus, according to claim 8, wherein said predetermined width of said elongated strip is between about 4.25 inches and about 5 inches.

10. The apparatus, according to claim 1, wherein said preselected material is selected from one of plastic, rubber, nylon, and synthetic leather.

11. The apparatus, according to claim 10, wherein said rubber is a synthetic rubber.

12. The apparatus, according to claim 11, wherein said synthetic rubber is a thermoplastic elastomer.

13. The apparatus, according to claim 1, wherein said means for securing said elongated strip further includes at least one of snaps, hooks and buckles.

14. The apparatus, according to claim 1, wherein said apparatus further includes a weather proof cover which fits over such laptop computer with said apparatus attached to such laptop computer, leaving said handle member uncovered, so as to protect such computer from rain and other weather elements.

15. The apparatus, according to claim 4, wherein said elongated strip passes through a portion of said handle member as said elongated strip encircles such laptop computer.

16. The apparatus, according to claim 15, wherein said portion of said handle member is a slot disposed closely adjacent where said handle member is securely attached to said second end of said elongated strip.
